(19) United States
(12) Patent Application Publication
(10) Pub. No.: US 2015/0235202 A1
(43) Pub. Date: Aug. 20, 2015

(54) METHOD AND SYSTEM FOR CASHLESS TRANSACTIONS AT VENDING MACHINES

(71) Applicant: Eazy Coin Corp., Miami, FL (US)

(72) Inventor: Jose Rafael Zabala, Doral, FL (US)

(73) Assignee: Eazy Coin Corp., Miami, FL (US)

(21) Appl. No.: 14/293,490

(22) Filed: Jun. 2, 2014

Related U.S. Application Data
(60) Provisional application No. 61/942,297, filed on Feb. 20, 2014.

(51) Int. Cl. G06Q 20/32; H04L 29/08; G06Q 20/18; G05B 15/02

(52) U.S. Cl. CPC G06Q 20/327; G05B 15/02; H04L 67/10; G06Q 20/3278; G06Q 20/18

(57) ABSTRACT

Disclosed is a system and method for enabling cashless purchases at a vending machine. A conventional vending machine may be modified by attaching to it a Bluetooth transceiver that can communicate with a mobile telephone's Bluetooth interface. The vending machine's Bluetooth interface may be connected to an MDB bus to communicate with the vending machine's VMC processor. The VMC processor may be reprogrammed so that it can poll the vending machine's Bluetooth reader. The VMC may then poll the Bluetooth interface to detect a payment signal sent by the mobile telephone and deliver and item, ordered through the mobile phone's graphical user interface, to a customer.

### CROSS-REFERENCE TO RELATED APPLICATION

This Non-provisional Utility application claims priority to U.S. Provisional Patent Application Ser. No. 61/942,297, filed on Feb. 20, 2014.

### FIELD OF THE INVENTION

The present invention relates to the field of applications for portable multifunction devices such as cellular telephones. More specifically, the invention relates to using a mobile device for payment at a vending machine or similar machine that accepts bills, coins, credit cards in return for a product or service.

### BACKGROUND OF THE INVENTION

Vending machines are well known in the art. Generally they serve the purpose of selling beverages and snacks but can also be used to sell other items such as newspapers, etc. Most vending machines are operated by vending companies that offer a wide variety of services, however, companies producing beverages, also own and service a great number of vending machines. Item selection in a vending machine is performed by selecting the item using a user interface of the vending machine. The user interface of the vending machine generally contains push buttons for the user to choose the desired item. Most vending machines include a system for receiving payment for the particular article and a system for dispensing the article from the dispensing department to the merchandise removal area. When the consumer makes an item selection after payment has been received, the machine releases the product such that it falls in an open compartment at the bottom, or into a cup. The product may also become available by the unlocking of a door, drawer, turning of a knob, etc. Sometimes the product is not just released but prepared.

Generally, a central processor on the Vending Machine Controller (VMC) board in the vending machine is responsible for the control of and activities within the vending machine which include, but are not limited to: 1) communication with the payment system to keep track of the inserted amount of credit, 2) monitor button presses on the selection panel to check if the consumer selects an item, 3) control motor relay in the vending machine to release a product through the dispenser unit, 4) monitor drop sensor to check if a product is sold-out, and 5) monitor temperature sensor and control temperature of items within the vending machine by means of the cooling system. The VMC board contains a microcontroller, which is typically an Intel 8051 derived microcontroller, or a Motorola 68HC11 derived microcontroller, or other microcontroller series.

People skilled in the art are familiar with the different payment systems available within the vending industry. Vending machines that accept payment contain a payment system like a currency detector or a cashless device. Typically coin acceptors/changers, bill validators/recyclers and cashless devices are connected to the VMC in the vending machine by means of a serial interface, such as MDB/ICP, Executive, VCCS, BDV, Micromech, Simplex III, HII, etc. The most widely accepted serial interface within the vending industry is the MDB standard defined by NAMA (National Automatic Merchandising Association). The MDB/ICP protocol (Multi-Drop Bus/Internal Communication Protocol) is a serial bus interface for electronically controlled vending machines. It standardizes vending machines that employ electronic controls so that all vending and peripheral equipment communicate identically. The MDB/ICP protocol is available from NAMA (www.vending.org).

As explained in U.S. Patent Pub. No. 2013/0013107 A1, which is incorporated herein by reference, one prior-art solution upgrades a traditional vending machine to a modern vending machine with 1) alternative payment means (such as mobile phone payment or Internet payment solution, etc.), and/or 2) real-time telemetry functionality (for remote monitoring and controlling a vending machine), and/or 3) integrated multimedia features (such as a graphical user interface, multimedia advertising and info kiosk capabilities), and/or 4) intelligent energy management (to reduce energy costs), by replacing the original VMC board with a modern VMC board which provides any, a combination of some, or all of, the above features on-board. The disadvantage of this known system is that it includes costly components and it is not suitable for additionally installing into already operating, conventional beverage vending machines, without the need to replace the entire conventional VMC board. The VMC board needs custom interfaces (e.g., connection to a selection panel, connection to a display panel, connection to a sold-out LED panel, connection to vend motors, connection to a temperature probe, connection to a refrigerator and evaporator, connection to a drop sensor, connection to a door sensor, etc., to integrate it in different vending machine brands and types, and therefore, needs to be realized in different versions and badges: this makes the VMC board and associated custom interfacing cables very expensive, as it is a custom solution produced in low quantities. Accordingly, the installation of this known system is very expensive, and it is not suitable for a cost efficient integration.

Another problem existing in the art is that customers may not have bills or coins in their possession at the desired time of purchase. Even if the vending machine is equipped with a credit card slot, there are delays and other variables associated with the processing of a credit card which might affect the purchasing experience. Similar problems exist with respect to other types of machines that accept payment in exchange for a product or service.

Still another problem in the art relates to the use of smart phones to make a payment, as the currently available alternatives require the smart phone or mobile device to store credit card information locally in the phone or mobile device in order to execute a purchase transaction. This may result in the customer's credit card information being compromised in the event of theft or in the event that a wireless signal transmitting the credit card information is intercepted.

The present invention enables a conventional vending machine or other machine accepting bills, coins, or credit cards to accept payment via a mobile phone equipped with a Bluetooth device, in addition to receiving payment through a coin/bill collector or a credit card slot, by installing a Bluetooth interface in the vending machine and reprogramming the VMC to add the Bluetooth option to the MDB cycle.

### SUMMARY

The following presents a simplified summary of the invention in order to provide a basic understanding of some aspects of the invention. This summary is not an extensive overview of the invention. Rather than specifically identify key or critical elements of the invention or to delineate the scope of the invention, its purpose, inter alia, is to present some concepts of the invention in a simplified form as a prelude to the more detailed description that is presented later.

In accordance with one embodiment, the present disclosure describes a system and method for enabling cashless purchases of products or services at a vending machine, for example. In one embodiment, a conventional vending machine may be modified by attaching to it a Bluetooth interface that can communicate with a mobile telephone's Bluetooth interface. The vending machine's Bluetooth interface may be connected to an MDB bus to communicate with the VMC processor. The VMC processor may be reprogrammed so that it can poll the vending machine's Bluetooth reader. The VMC may then poll the Bluetooth interface to detect a payment signal sent by the mobile telephone and deliver and item, ordered through the mobile phone's graphical user interface, to a customer.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following description of the invention when considered in conjunction with the drawings.

### BRIEF DESCRIPTION OF THE DRAWINGS

The accompanying drawings, which are incorporated in and constitute a part of this specification, show certain aspects of the present invention and, together with the description, help explain some of the principles associated with the invention.

FIGS. 1A-D illustrate a flowchart that describes the global transactions flow in accordance with an embodiment;

FIG. 2 illustrates a high level view an interconnection of different peripherals and a VMC though use of an MDB bus in accordance with one embodiment;

FIGS. 3 and 4 illustrate a sequence of communications between the VMC and the reader installed on the vending machine in accordance with one embodiment;

FIGS. 5-18 illustrate exemplary screenshots of a smartphone application used to make cashless payments in accordance with one embodiment;

FIG. 19 illustrates signals exchanged between a processor in the vending machine and auxiliary devices in accordance with one embodiment;

FIGS. 20-21 illustrate sample reports in accordance with one embodiment;

FIG. 22 illustrates a QR image displayed on a mobile device in accordance with one embodiment;

FIG. 23 illustrates a sticker with a QR code attached to a vending machine in accordance with one embodiment;

FIG. 24 illustrates a screen displayed on a mobile device so that the user can confirm selection of product in accordance with one embodiment;

FIG. 25 illustrates a map displayed on a mobile device and showing locations of vending machines equipped with the Bluetooth or NFC interface device in accordance with one embodiment;

FIG. 26 illustrates a merchant user interface in accordance with one embodiment;

FIGS. 27-28 illustrate sample reports in accordance with one embodiment;

FIG. 29 illustrates a user interface to add a vendor machine in accordance with one embodiment;

FIG. 30 illustrates a user interface showing vendor machines and their associated QR codes in accordance with one embodiment;

FIG. 31 illustrates a map identifying the location of a vending machine and the products available for that vending machine in accordance with one embodiment;

FIG. 32 illustrates a system architecture in accordance with one embodiment; and;

FIGS. 33A-B illustrate a database schema in accordance with one embodiment.

### DETAILED DESCRIPTION OF ILLUSTRATIVE EMBODIMENTS

Reference will now be made in detail to embodiments, examples of which are illustrated in the accompanying drawings. The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with certain aspects related to the invention.

Embodiments of applications executed by portable multifunction devices, user interfaces for such devices, and associated processes for using such devices are described. In some embodiments, the device is a portable communications device such as a mobile telephone that also contains other functions, such as PDA and/or music player functions.

For simplicity, in the discussion that follows, a prior art portable multifunction device that includes a touch screen is used as an exemplary embodiment for executing the applications of the present invention. A prior art portable multifunction device such as an iPhone™ (or a similar device a Bluetooth interface) to that disclosed in U.S. Pat. No. 7,479,949, incorporated herein by reference, can be used to execute the applications of the present invention. The applications can also be executed in portable multifunction devices that do not include a touch screen for inputting information, but that rely instead on a more conventional mechanism, for example point-and-click, keypad, keyboard, or click-wheel mechanisms.

In addition to supporting the applications of the present invention, the portable multifunction device utilized in at least one embodiment can support a variety of applications, such as one or more of the following: a telephone application, a video conferencing application, an e-mail application, an instant messaging application, a blogging application, a photo management application, a digital camera application, a digital video camera application, a web browsing application, a digital music player application, and/or a digital video player application.

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In this document, the term “or” is used to refer to a nonexclusive or, unless otherwise indicated. Furthermore, references to “one embodiment” are not intended to be interpreted as excluding the existence of additional embodiments that also incorporate the recited features.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

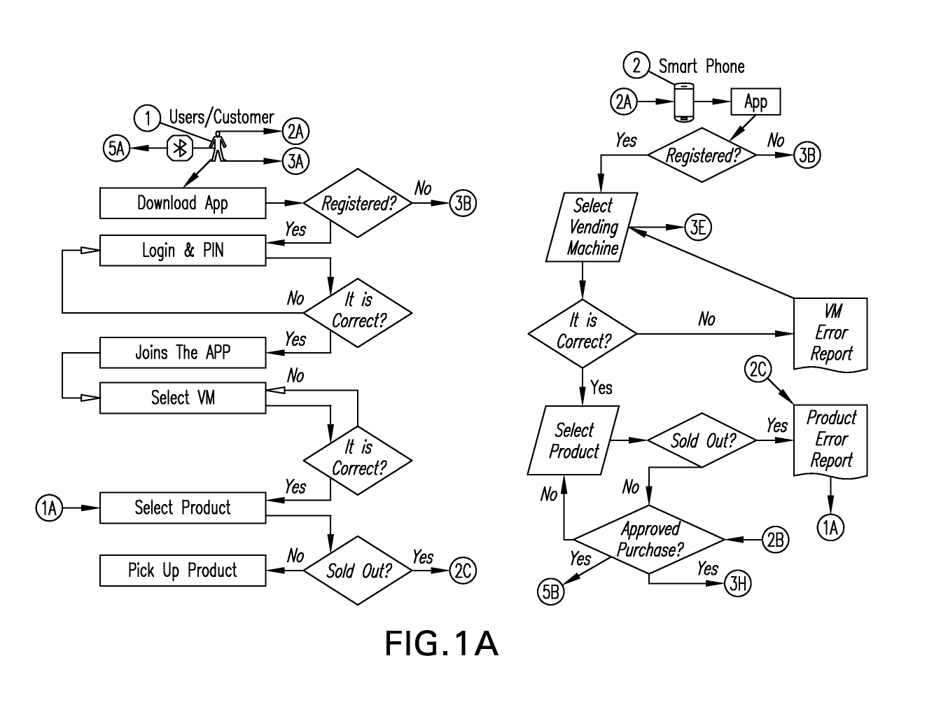

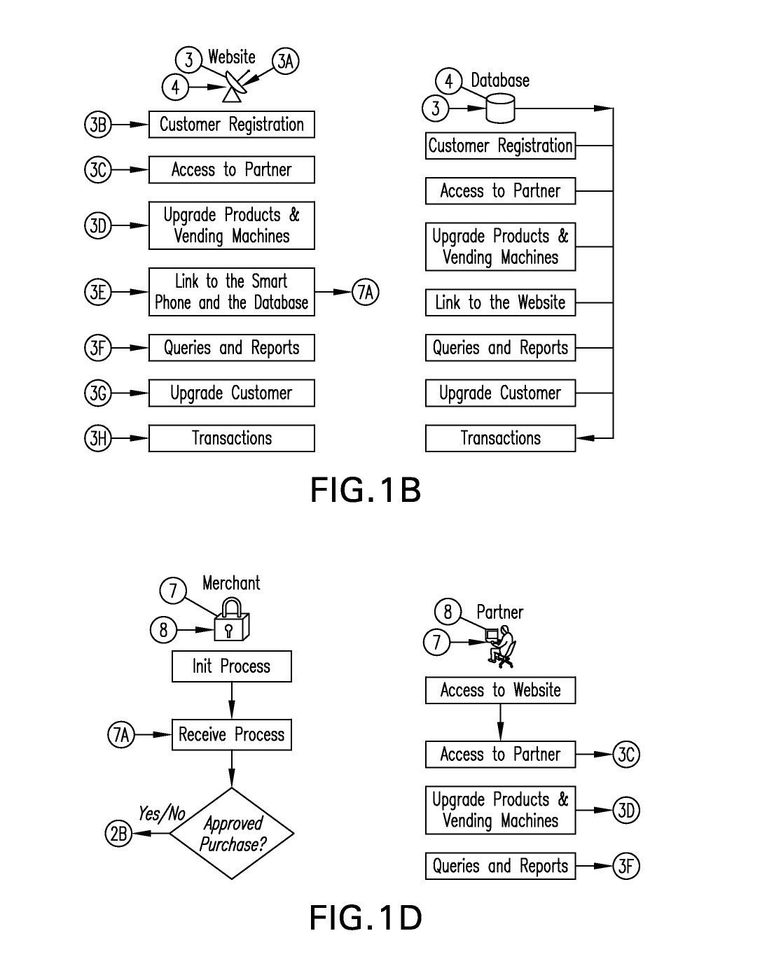

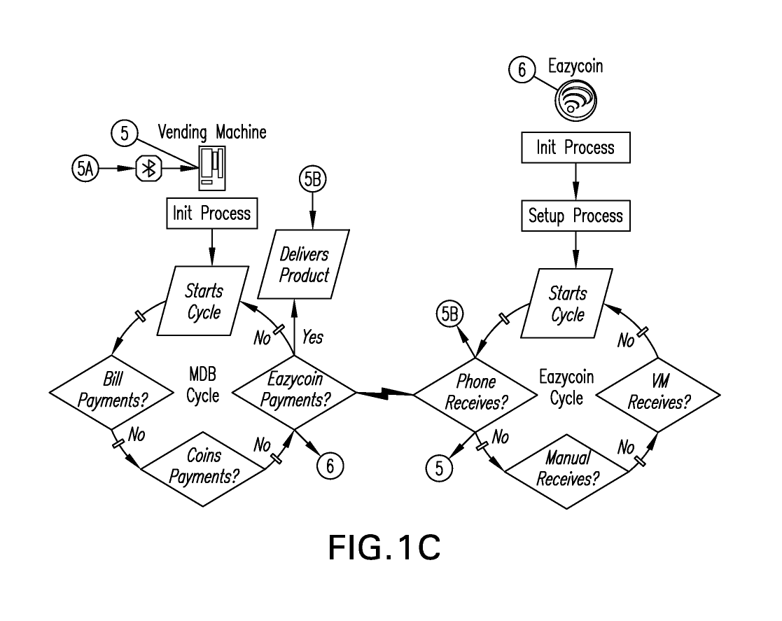

FIGS. 1A-D illustrates a flowchart that describes the global transactions flow in accordance with an embodiment. Numeral 1 in FIGS. 1A-D indicates transactions performed by users or customers that desire to purchase or rent an item from the vending machine in accordance with one embodiment. As an initial step, the user may download the application from an app store and install it on the smartphone. When using the application for the first time, the user may register by providing information such as name, a password and a PIN number. To use the smartphone app for purchases, the user may sign in the application and select the vending machine number displayed on the smartphone after scanning a quick response (QR) code displayed or posted on the vending machine. Alternatively, the machine ID number is selected by the mobile device after scanning of the QR code. The system will then attempt to match the vending machine with a machine ID stored in a database and if there is no match, the smartphone or mobile device will display a message to rescan the QR code or enter the machine ID number. Once the correct vending machine has been selected, the customer is ready to make a purchase and he may choose the product displayed on the smart phone or could directly select the product through physical contact with the vending machine once the machine's processor has verified that the transaction through the app has been authorized. If the product is sold out, the system will notify and instruct the user to make another selection.

The system may verify again whether the vending machine is the intended machine. The additional verification may be implemented in the event that a user walks away from the vending machine of interest and approaches a nearby vending machine. The system will then check if the transaction is correct or can go forward (e.g., the item selected has not been sold out). The smartphone will communicate with the Bluetooth transceiver in the vending machine and sends the order to the vending machine to deliver the product. The system will check whether there is availability of the product for sale. If the product is not available, both the machine and the Smartphone may display a message: “SOLD OUT”, otherwise the product will be dispatched. While this process is running the system communicates (with encryption) with the mechanism responsible to collect the transactions and charges the customer order. In one embodiment, the system implements communications between the smartphone and the vending machine through Bluetooth low energy.

Numeral 2 in FIGS. 1A-D indicates smartphone transactions in accordance with one embodiment. After downloading the application from the app store and a record is created in a database, the user will run the app, and enter a PIN number or password. The app receives the selection of the vending machine number through scanning of the QR code printed on a label attached to the vending machine and will also receive the product selection. The system checks the vending machine number using an encrypted code. Upon receiving the product selection, the smartphone synchronizes with the vending machine's Bluetooth interface.

The system checks the vending machine number by cross referencing with the database and verifies whether the transaction is correct and will check whether there is availability of the product for sale. The smartphone will communicate with the Bluetooth interface in the vending machine and send the order to the vending machine to deliver the product. If the product is not available, both the machine and the Smartphone may display a message: “SOLD OUT”, otherwise the product will be dispatched. While this process is running the system communicates with the mechanism responsible to collect the transactions and charges the customer order.

Numeral 3 in FIGS. 1A-D indicates transactions conducted through a web portal in accordance with one embodiment. Through use of the web portal, the following transactions can be conducted:

a. Registration and update of customers' information.

b. Registration and update of partners' information.

c. Assignment of vending machines to each partner.

d. Assignment of products for each vending machine.

e. Queries and reports for customers, partners and owners.

f. Links to the app on the phone and the database.

g. Upgrade products and vending machines.

The website handles transactions (e.g., authentication) and links with the database.

Numeral 4 in FIGS. 1A-D identifies information that can be stored in the database. For example, the database stores all of the information required by the system, such as:

a.—Customers or users information.

b.—Partners information.

c.—Vending Machines of each partner.

d.—Products of each Vending Machine.

e.—Queries and reports for customers, partners and owners.

f.—System transactions.

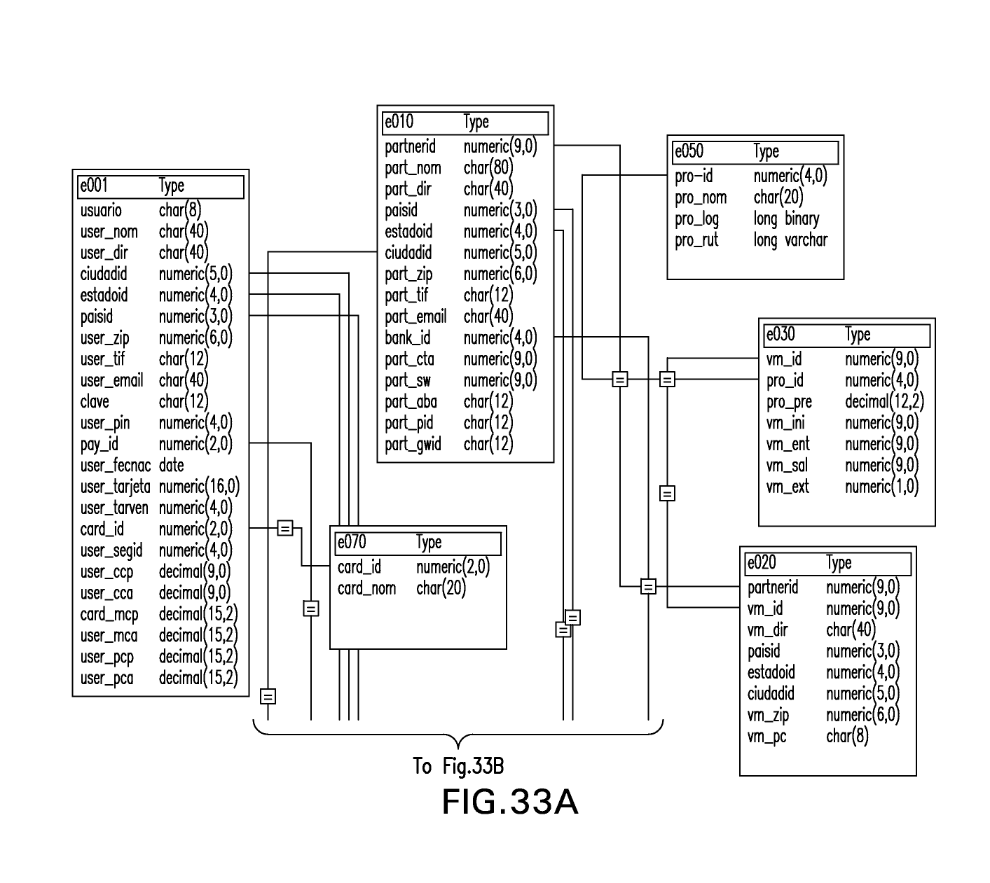

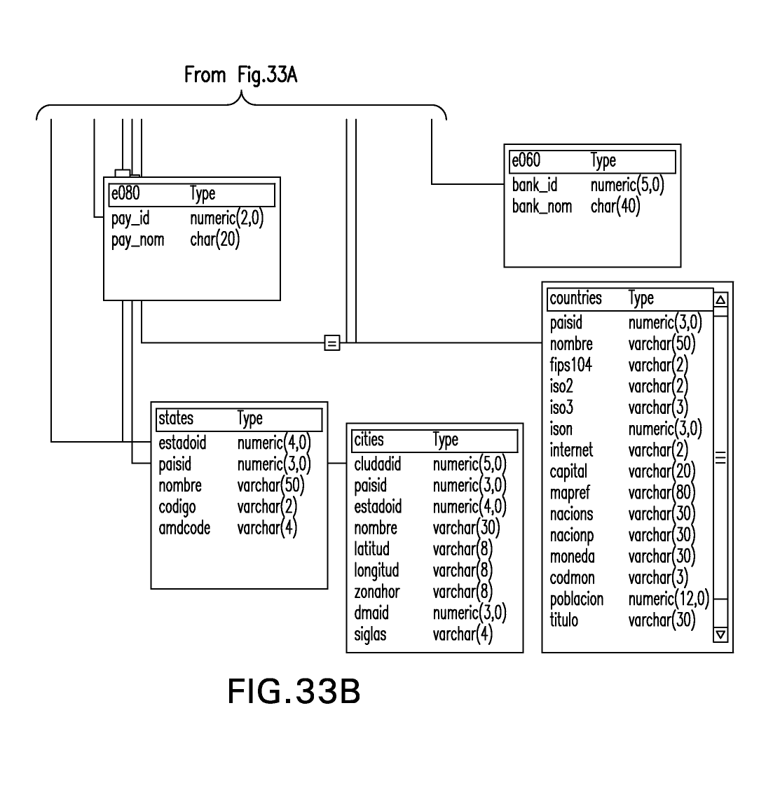

In one embodiment, the database schema may be implemented as illustrated in FIGS. 33A-B.

Numeral 5 in FIGS. 1A-D indicates transactions conducted by the vending machine in accordance with one embodiment The vending machine may operate in a constant cycle through its processor (MDB) by checking the type of payment received when a user is making a purchase (e.g., by sequentially polling the credit card slot, coin/bill collector and the Bluetooth interface). By linking to the vending machine's Bluetooth interface, the VMC takes over and performs operations. The Bluetooth interface (or Bluetooth transceiver) follows the the National Automatic Merchandising Association (NAMA) specifications.

Numeral 6 in FIGS. 1A-D indicates transactions conducted through the vending machine's Bluetooth transceiver in accordance with one embodiment. The Bluetooth transceiver is responsible for interacting with the vending machine and the smartphone. In accordance with one embodiment, this device has three basic procedures:

a—MDB interfacing that complies with NAMA specifications.

b—User interfacing for manual commands and diagnostics.

c—Bluetooth interfacing for communicating with the Smartphone's Bluetooth interface.

Numeral 7 in FIGS. 1A-D indicates transactions conducted by a merchant in accordance with one embodiment. The merchant is responsible for executing payments for customer purchases through credit card or debit card. The payment data is passed through the website and processed immediately.

A merchant account may be defined as a type of bank account that allows businesses to accept payments by payment cards, typically debit or credit cards. A merchant account is established under an agreement between an acceptor and a merchant acquiring bank for the settlement of payment card transactions. In some cases a payment processor, independent sales organization (ISO), or member service provider (MSP) is also a party to the merchant agreement. Whether a merchant enters into a merchant agreement directly with an acquiring bank or through an aggregator such as PayPal, the agreement contractually binds the merchant to obey the operating regulations established by the card associations.

Numeral 8 in FIGS. 1A-D indicates transactions conducted by a partner in accordance with one embodiment. The Partner is any owner of a vending machine that uses the vending machine's Bluetooth transceiver. This owner has the support of such organization and can make different processes through the disclosed website as creating new vending machine numbers, changing prices, sales consulting and viewing statistics.

In accordance with one embodiment of the present invention, when the vending machine is not equipped with communications means to exchange information with a credit card processor, etc., through the use of the Bluetooth interface it can still communicate with the smartphone, which in turn can be used as a communications bridge between the vending machine and the remote system for processing payments, etc. In a preferred embodiment the credit card processor need not authorize the transaction, but instead money is credited to the vending machine owner's bank account directly by a proprietary server tied to the app. Alternatively, the app can generate a request for approval of the transaction to the proprietary server and the proprietary server can send the encrypted credit card number corresponding to the user of the app to a merchant in order to process the transaction as if the customer would have paid with a credit card at the vending machine location.

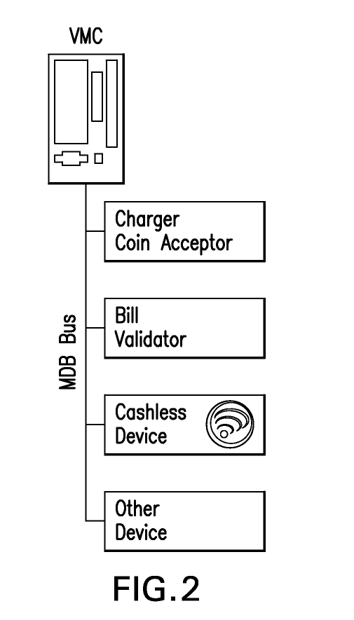

FIG. 2 illustrates a high level view an interconnection of different peripherals and a VMC though use of an MDB bus in accordance with one embodiment. The VMC constantly polls peripherals connected to the MDB bus, and upon receiving an input signal from one such device, it only listens to that device until completion or cancellation of a transaction.

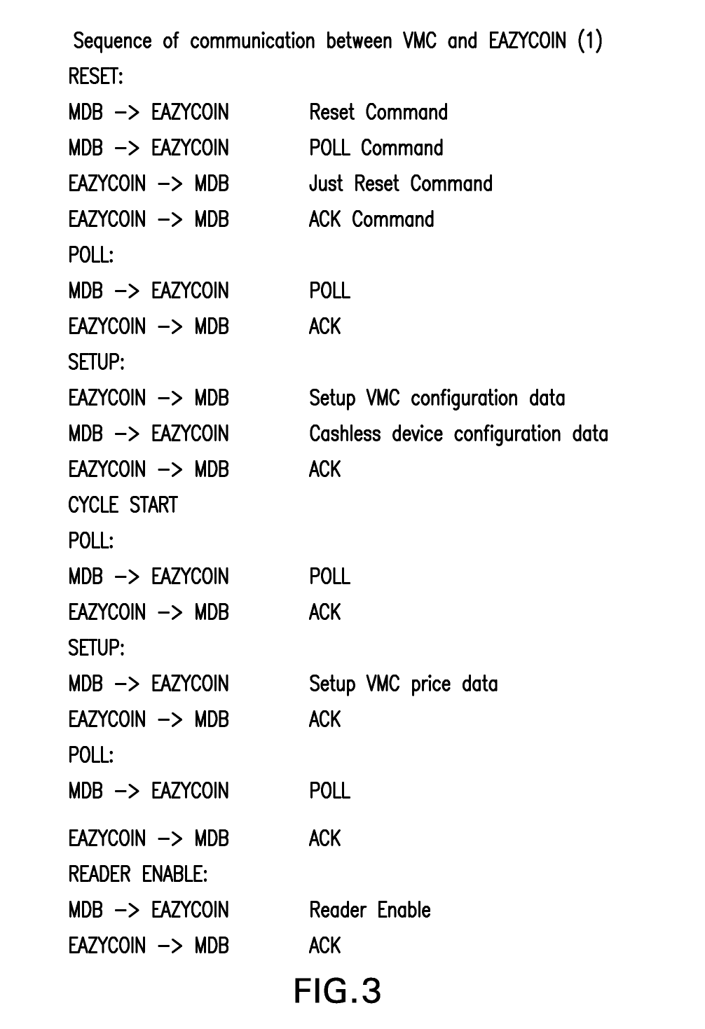

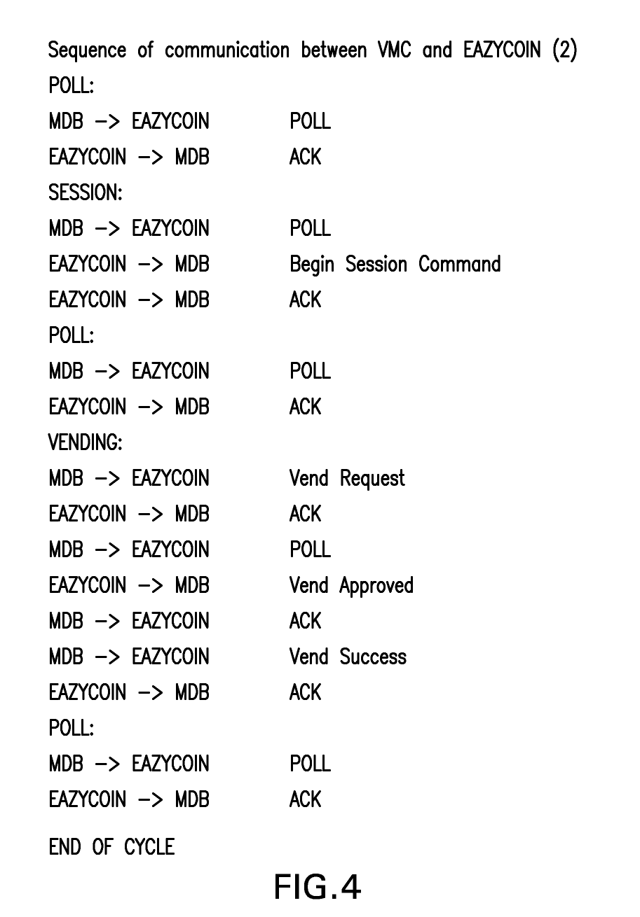

FIGS. 3 and 4 illustrate a sequence of communications between the VMC and the Bluetooth transceiver installed on the vending machine in accordance with one embodiment.

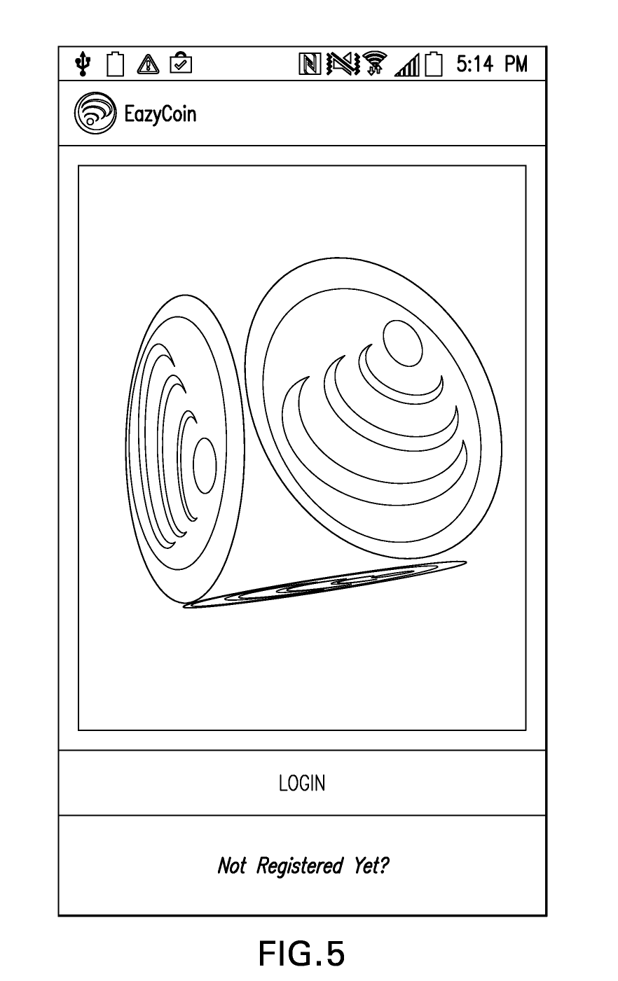

FIG. 5 illustrates a Welcome screen displayed on a user's mobile device in accordance with one embodiment.

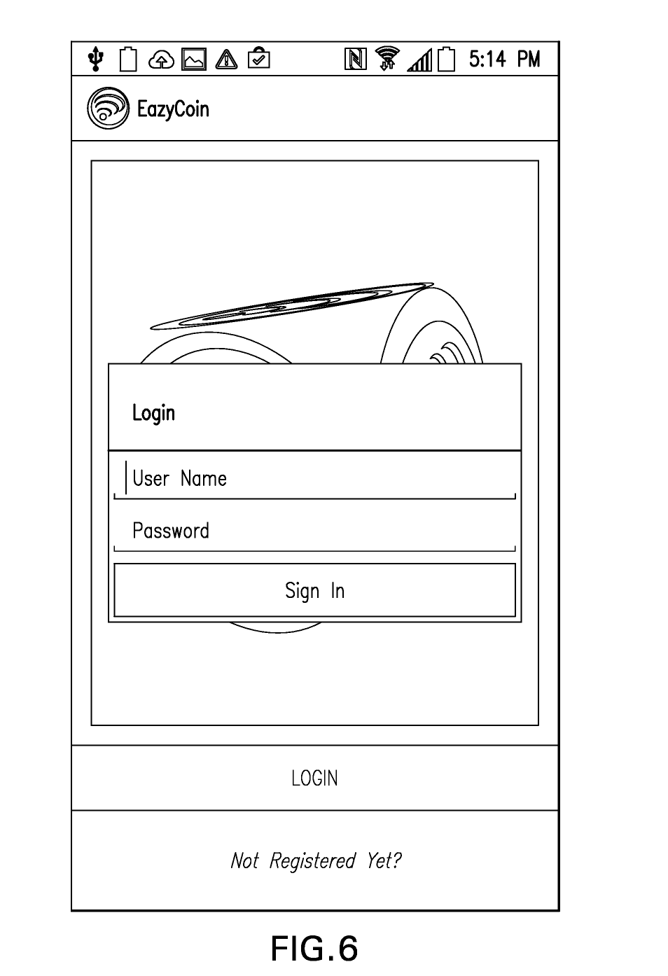

FIG. 6 illustrates a screen displayed on a user's mobile device prompting for the user's login and password in order to sign in to the app in accordance with one embodiment.

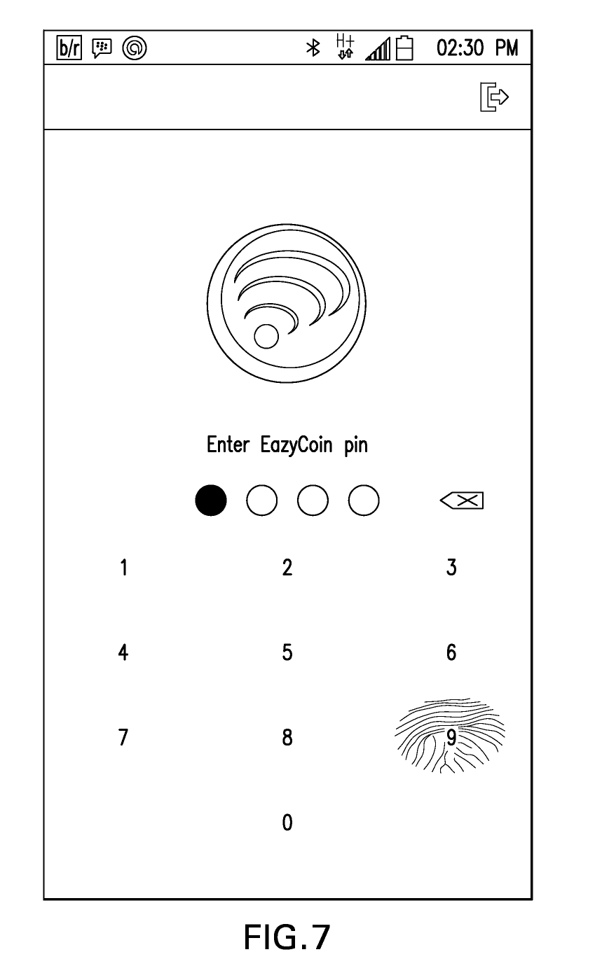

In the event that the user has already logged in, FIG. 7 illustrates a screen displayed on a user's mobile device requesting a PIN number in accordance with one embodiment.

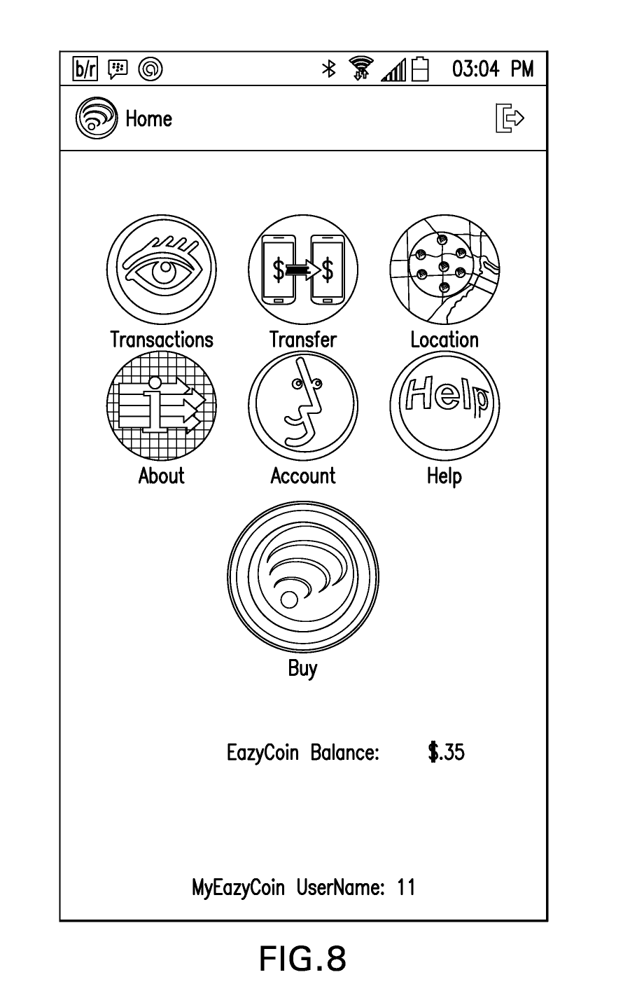

FIG. 8 illustrates a screen displayed on a user's mobile device showing a menu with options available through the app in accordance with one embodiment. For example, a user can access the option of transferring money from a bank or credit card account to an account associated with the app for transfer to a vending machine when conducting a purchase; can access a map showing vending machines in the vicinity of the user carrying the mobile device; can access records showing transactions; and can access account information, etc.

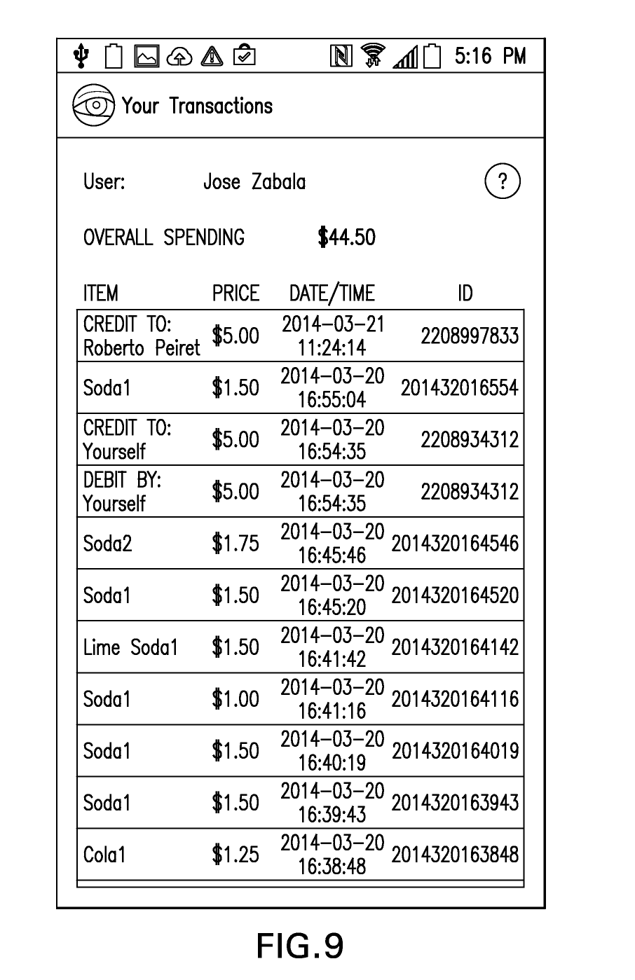

FIG. 9 illustrates a screen displayed on a user's mobile device showing purchase transactions conducted through use of the app in accordance with one embodiment.

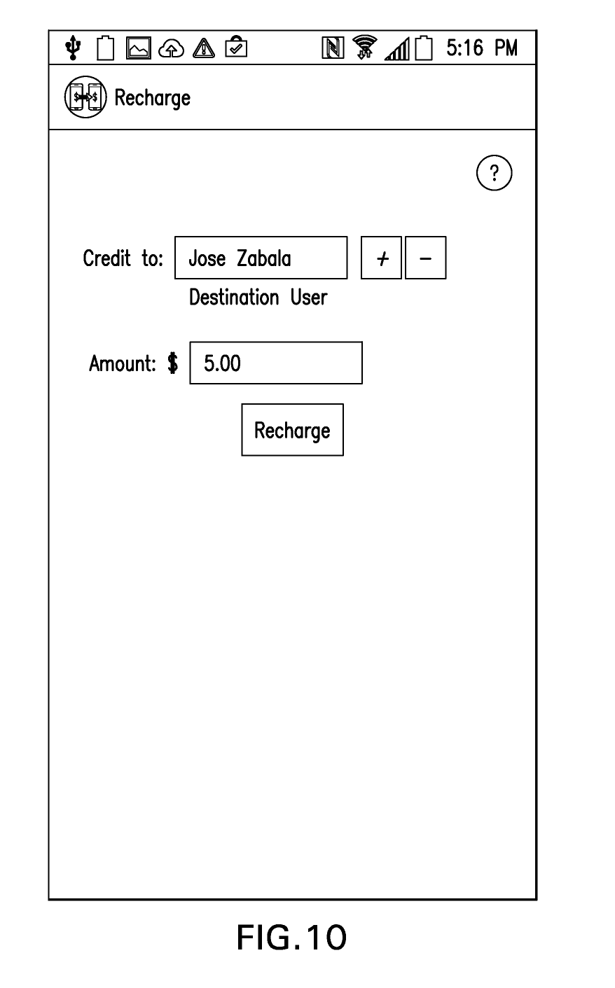

FIG. 10 illustrates a screen displayed on a user's mobile device that enables the user to transfer funds from a bank account or a credit card account into an account associated with the app for transfer to a vending machine when conducting a purchase in accordance with one embodiment.

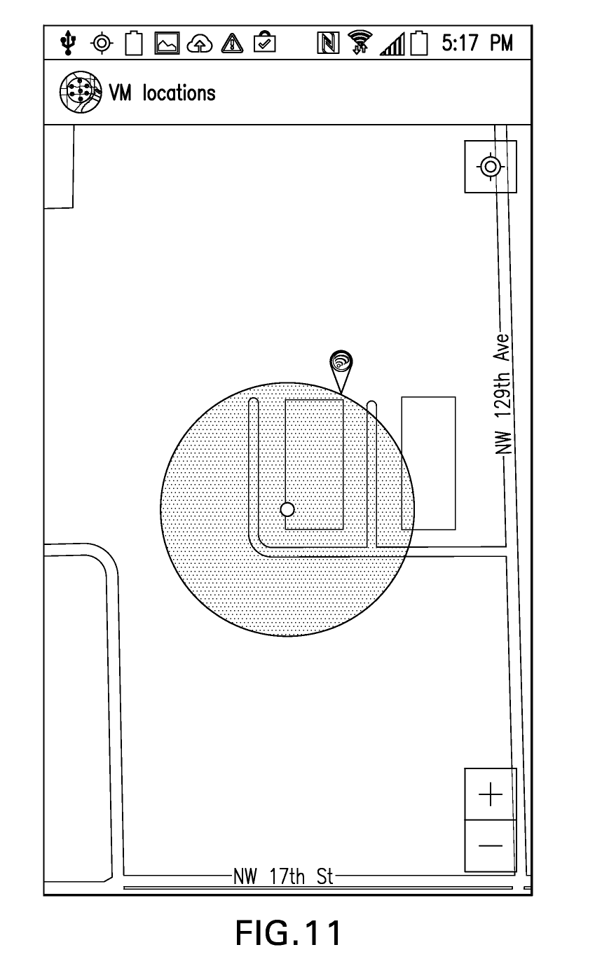

FIG. 11 illustrates a screen displayed on a user's mobile device that enables the user to access a map showing vending machines in the vicinity of the user carrying the mobile device in accordance with one embodiment.

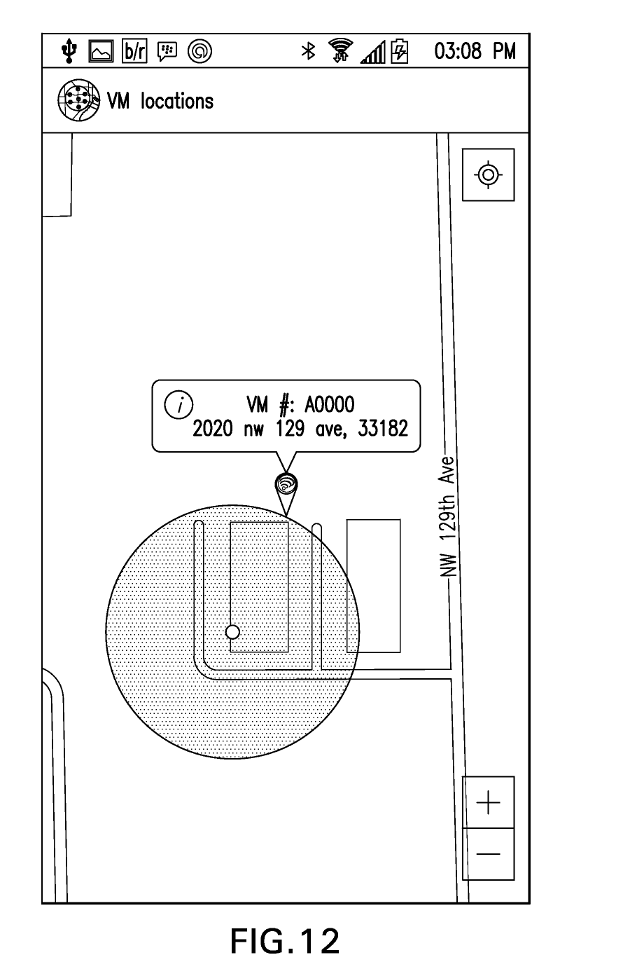

FIG. 12 illustrates a screen displayed on a user's mobile device that enables the user to access a map showing the physical addresses of vending machines in the vicinity of the user carrying the mobile device in accordance with one embodiment.

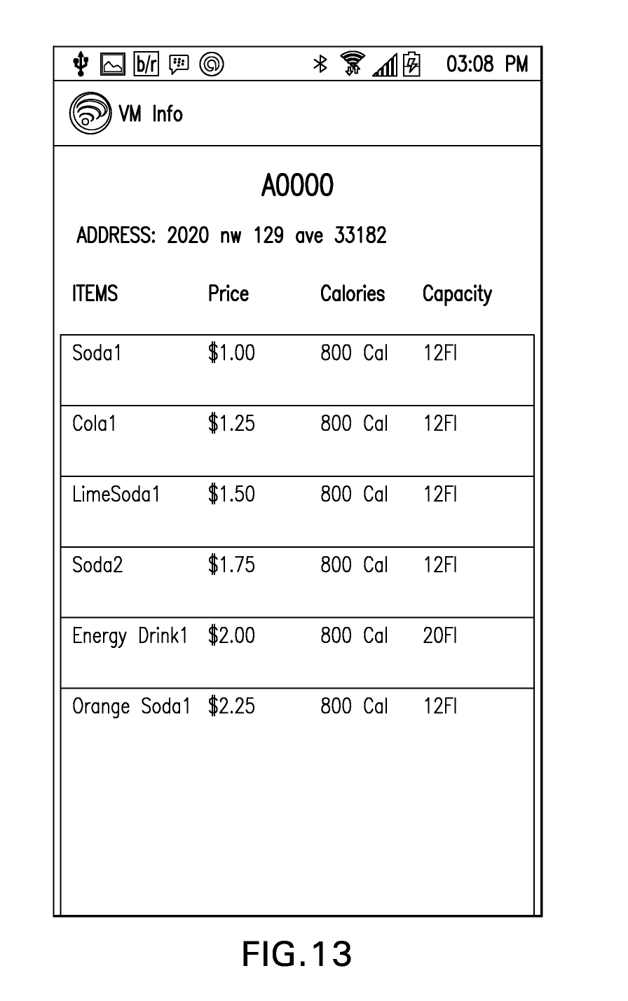

FIG. 13 illustrates a screen displayed on a user's mobile device that enables the user to access the options available at a vending machine which may be displayed in the same order displayed through a panel of the vending machine in accordance with one embodiment. For example, vending machine operators will have accounts supported by the proprietary server and they can set the order of products to be displayed by the user app to match the order in which the vending machine presents the products to the customer.

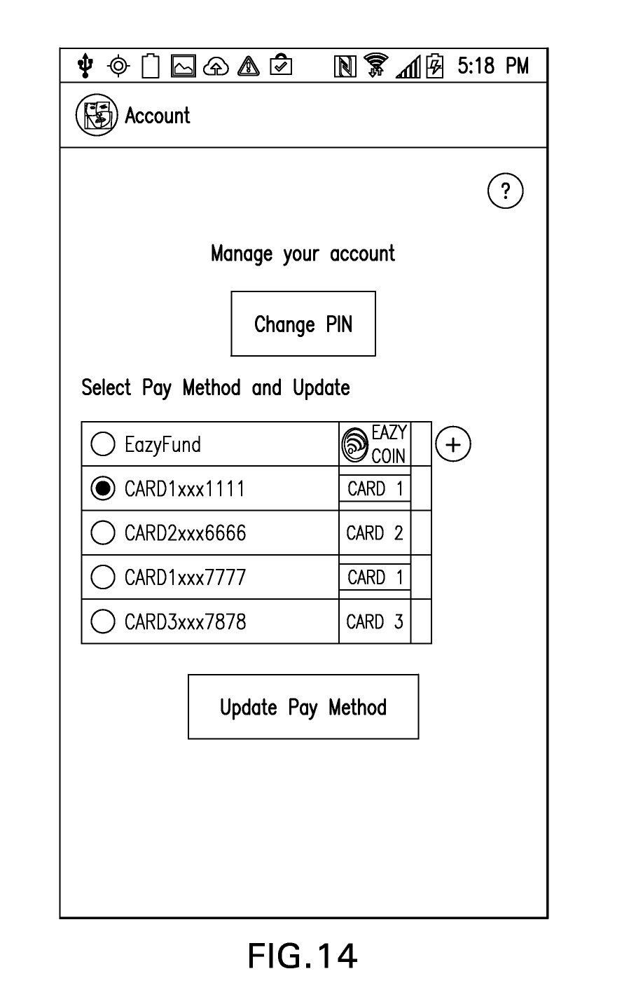

FIG. 14 illustrates a screen displayed on a user's mobile device that enables the user to select a payment method in accordance with one embodiment.

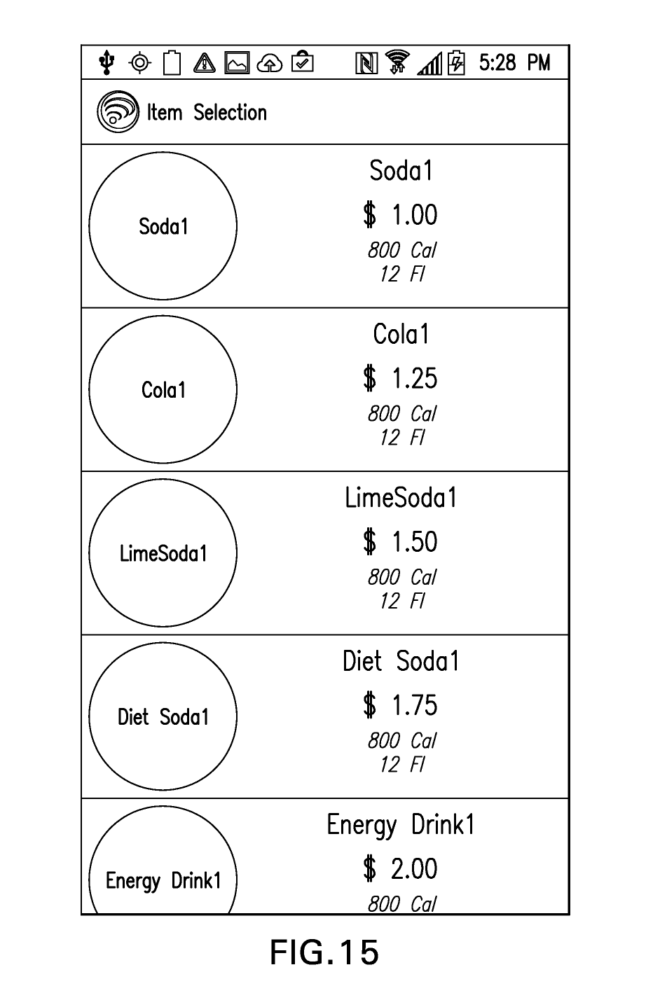

FIG. 15 illustrates a screen displayed on a user's mobile device that enables the user to access the options available at a vending machine which may be displayed in the same order displayed through a panel of the vending machine in accordance with one embodiment.

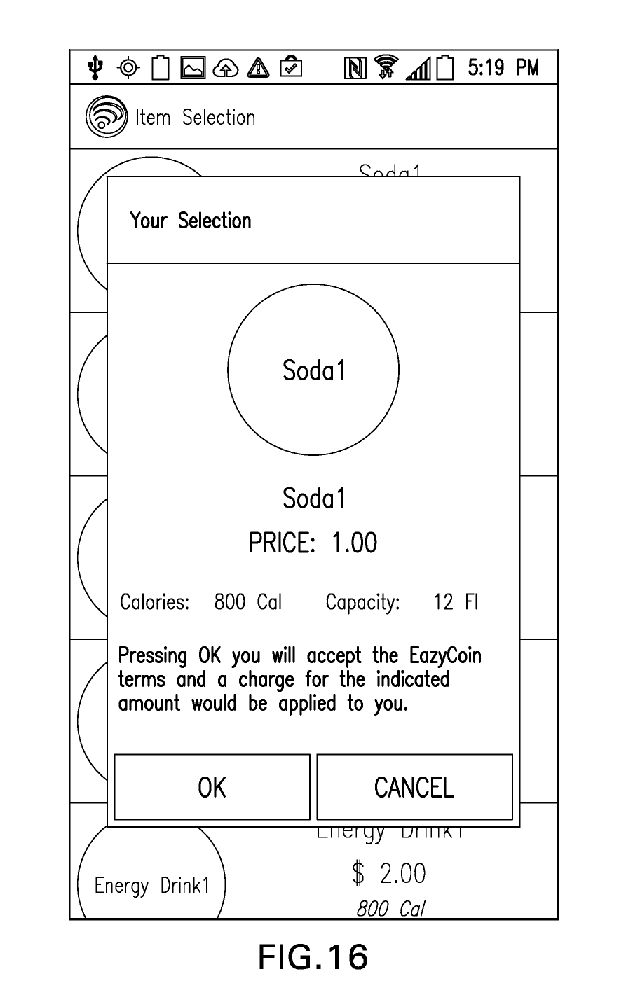

FIG. 16 illustrates a screen displayed on a user's mobile device that shows the item selected by the user for vending in accordance with one embodiment.

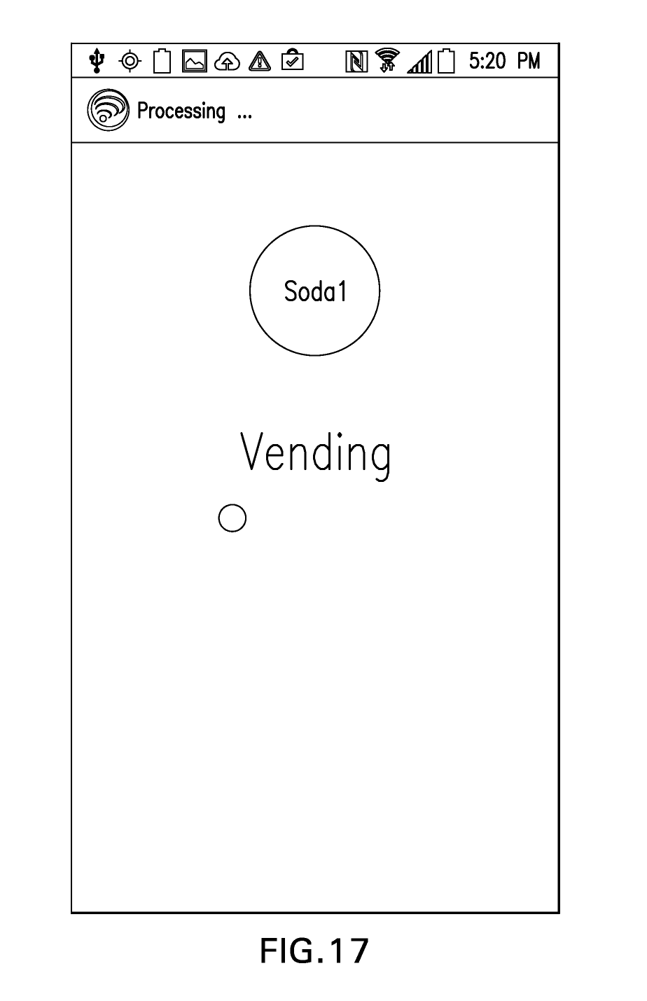

FIG. 17 illustrates a screen displayed on a user's mobile device that shows that the machine is currently vending in accordance with one embodiment.

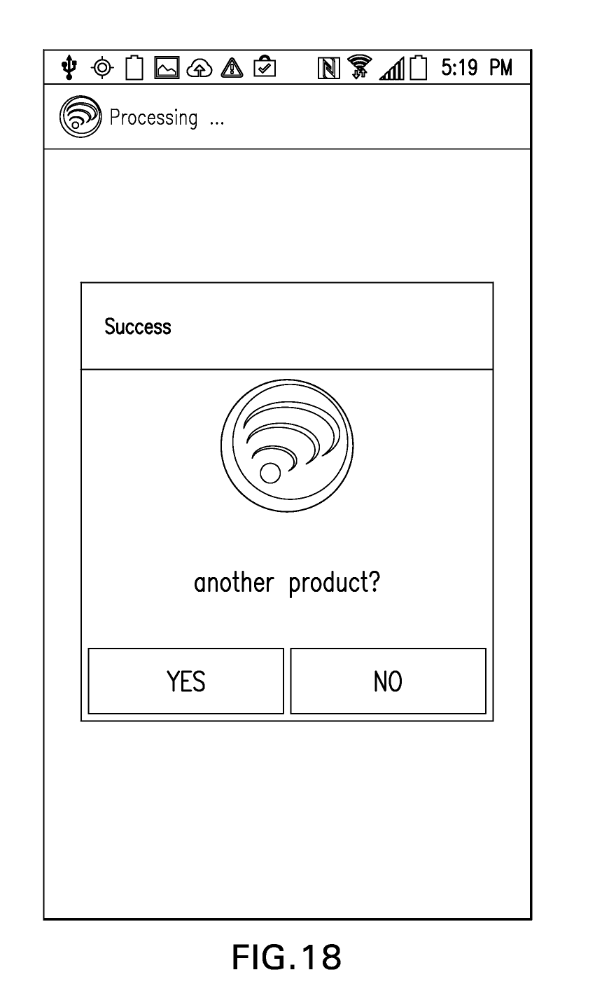

FIG. 18 illustrates a screen displayed on a user's mobile device that presents an option to purchase another item in accordance with one embodiment.

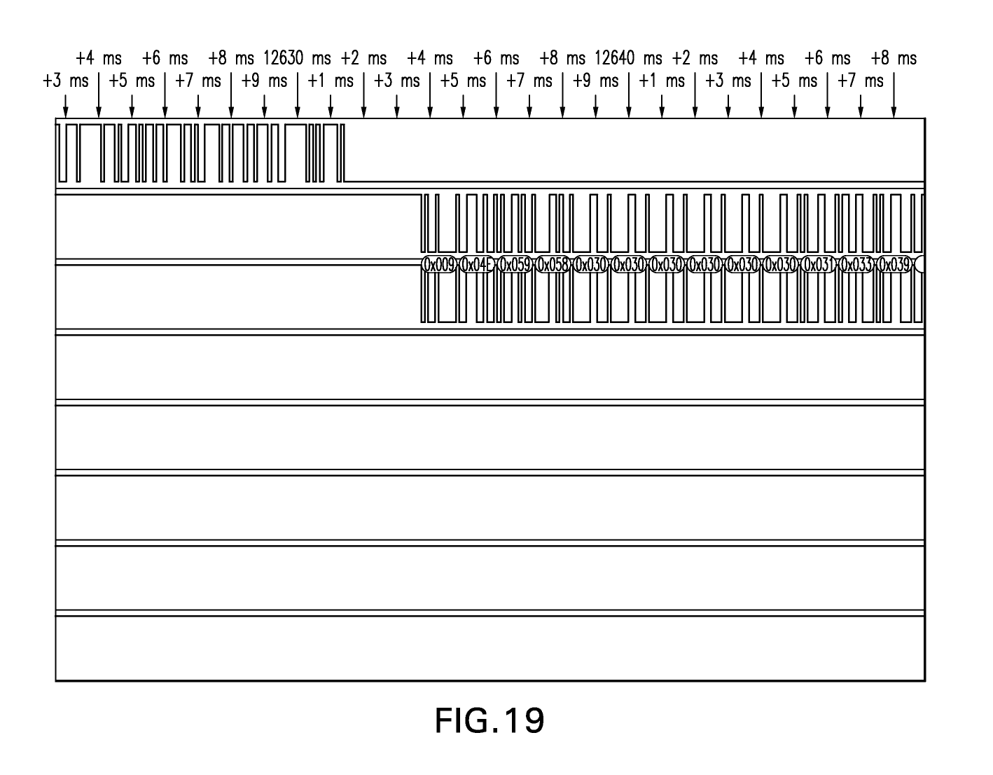

FIG. 19 illustrates signals reflecting that when the VMC is reset, it polls devices connected to the MDB bus which have pre-assigned or pre-programmed addresses in accordance with NAMA.

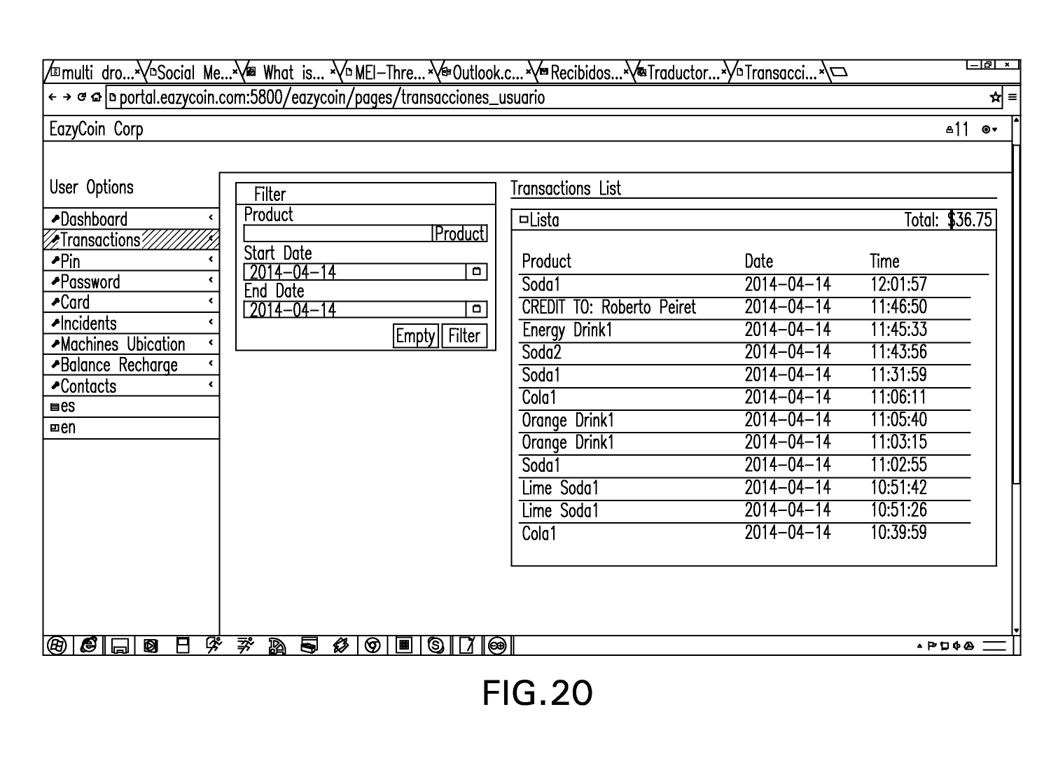

FIG. 20 illustrates a sample report with transactions for a particular vending machine in accordance with one embodiment.

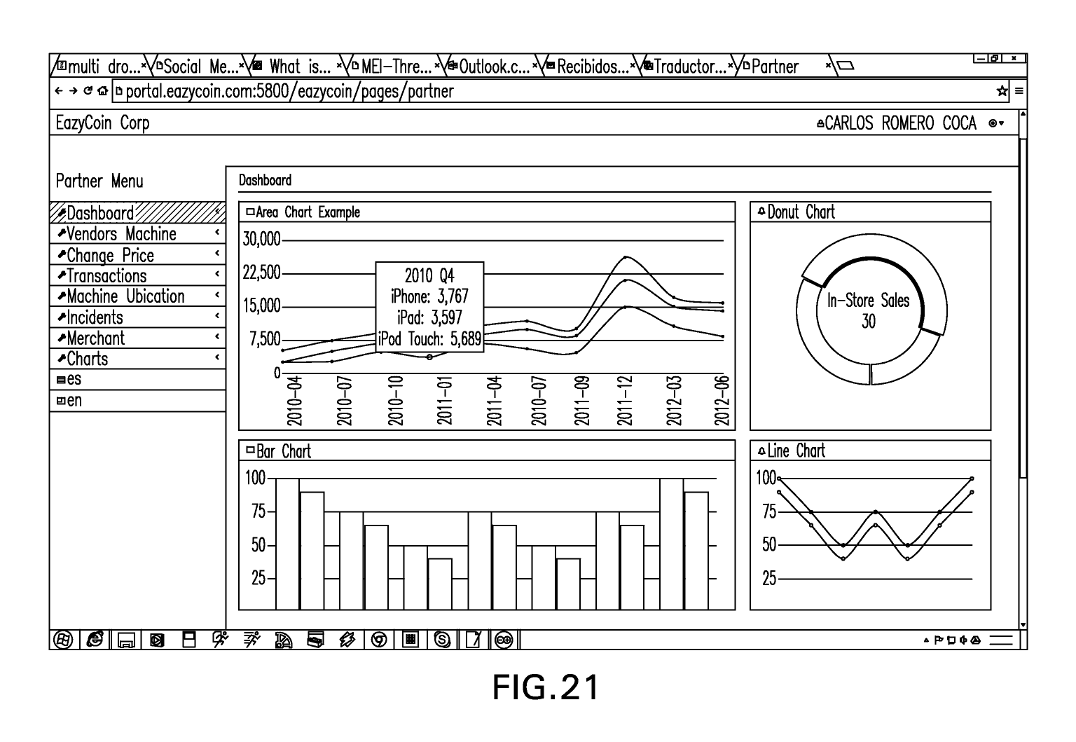

FIG. 21 illustrates sample sales report in accordance with one embodiment.

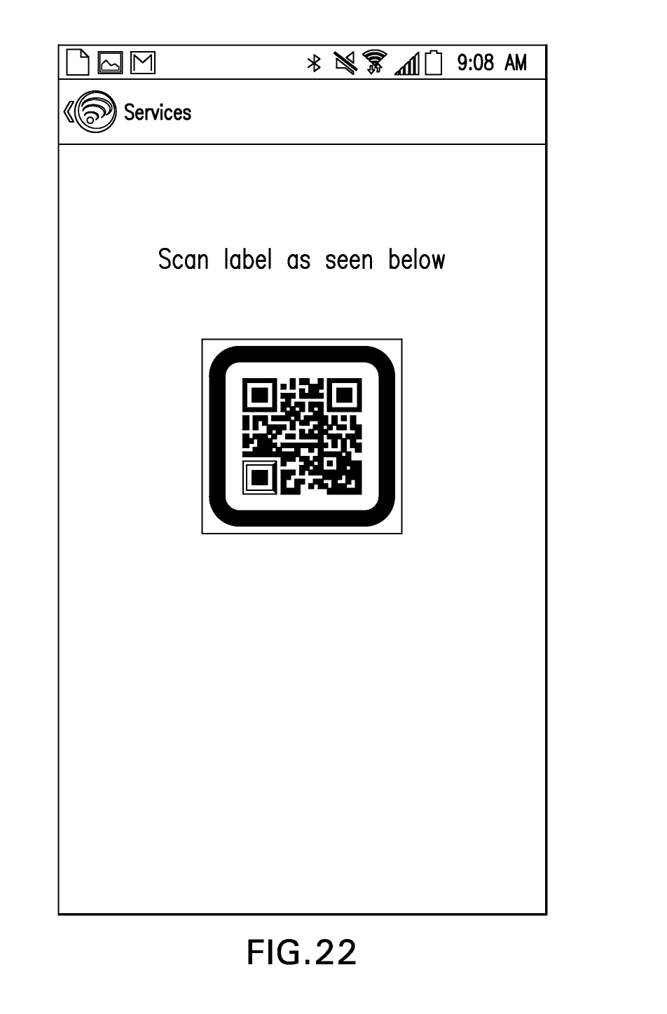

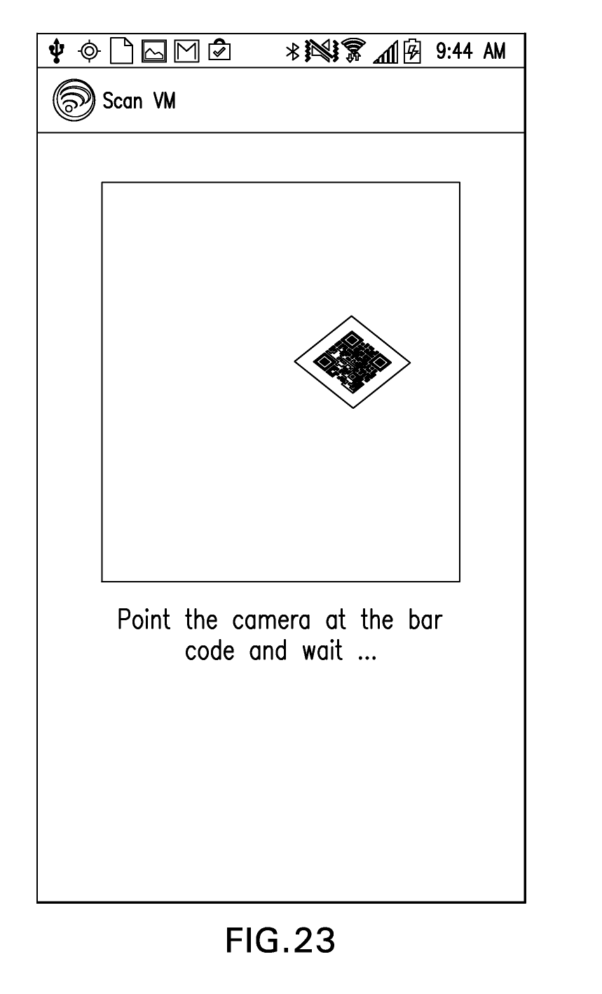

FIG. 22 illustrates a QR image displayed on a mobile device in accordance with one embodiment. FIG. 23 illustrates a sticker with a QR code attached to a vending machine in accordance with one embodiment.

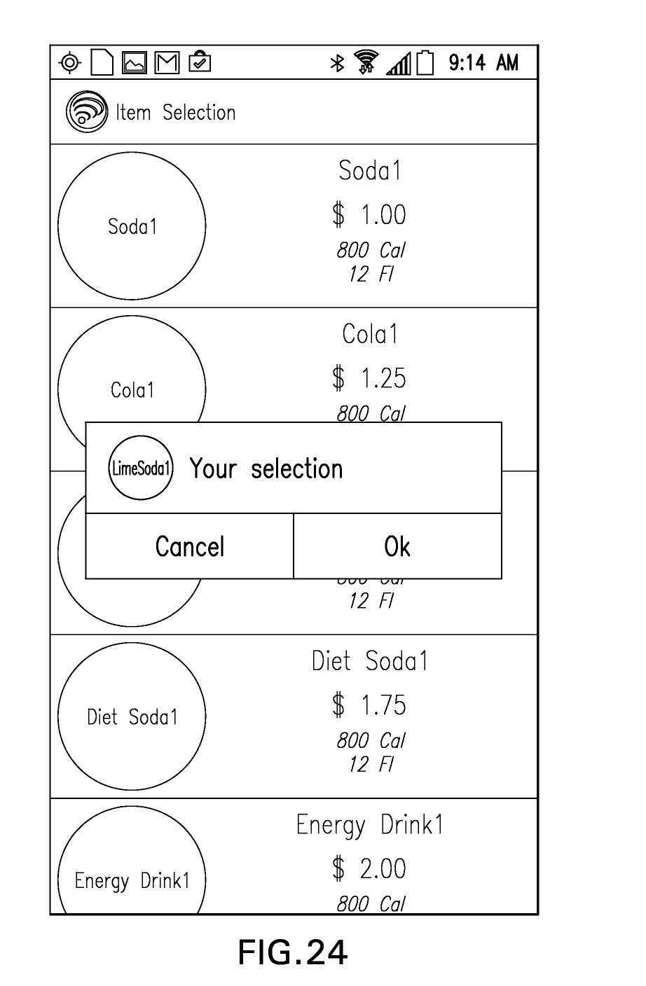

FIG. 24 illustrates a screen displayed on a mobile device so that the user can confirm selection of product in accordance with one embodiment.

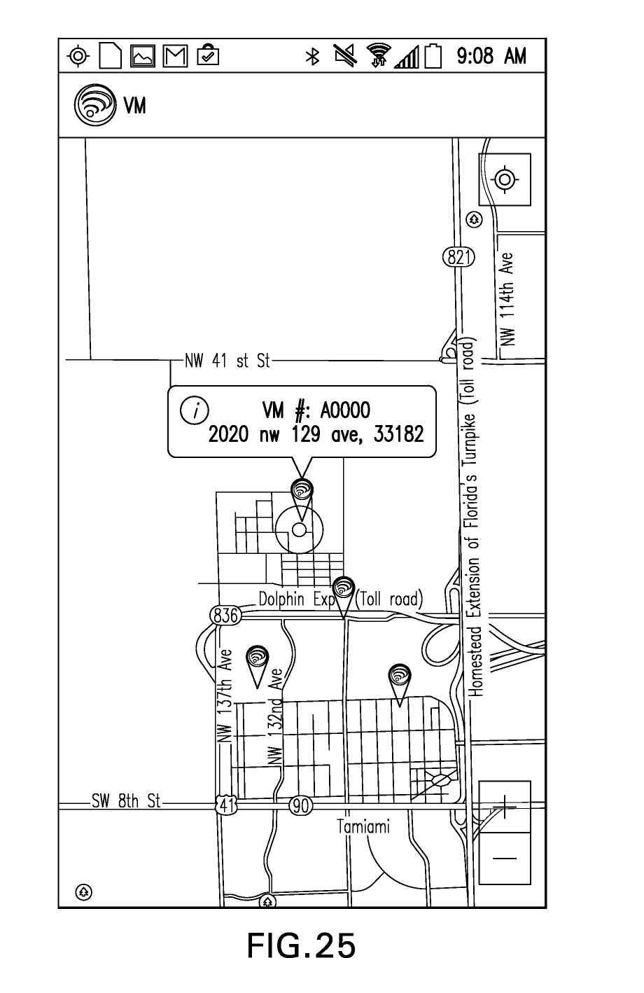

FIG. 25 illustrates a map displayed on a mobile device and showing locations of vending machines equipped with the Bluetooth or NFC interface device in accordance with one embodiment.

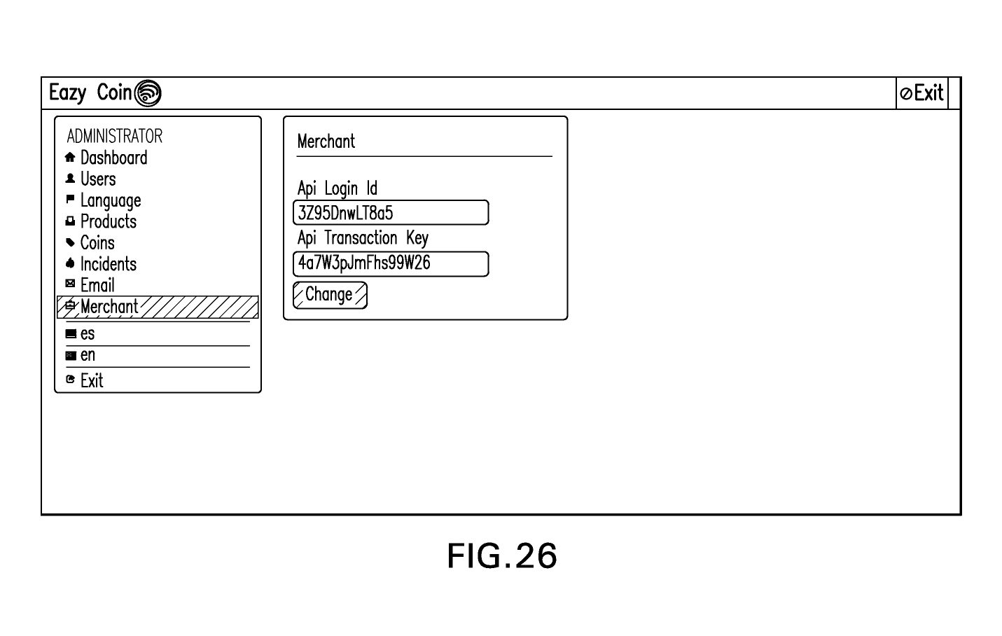

FIG. 26 illustrates a merchant user interface in accordance with one embodiment.

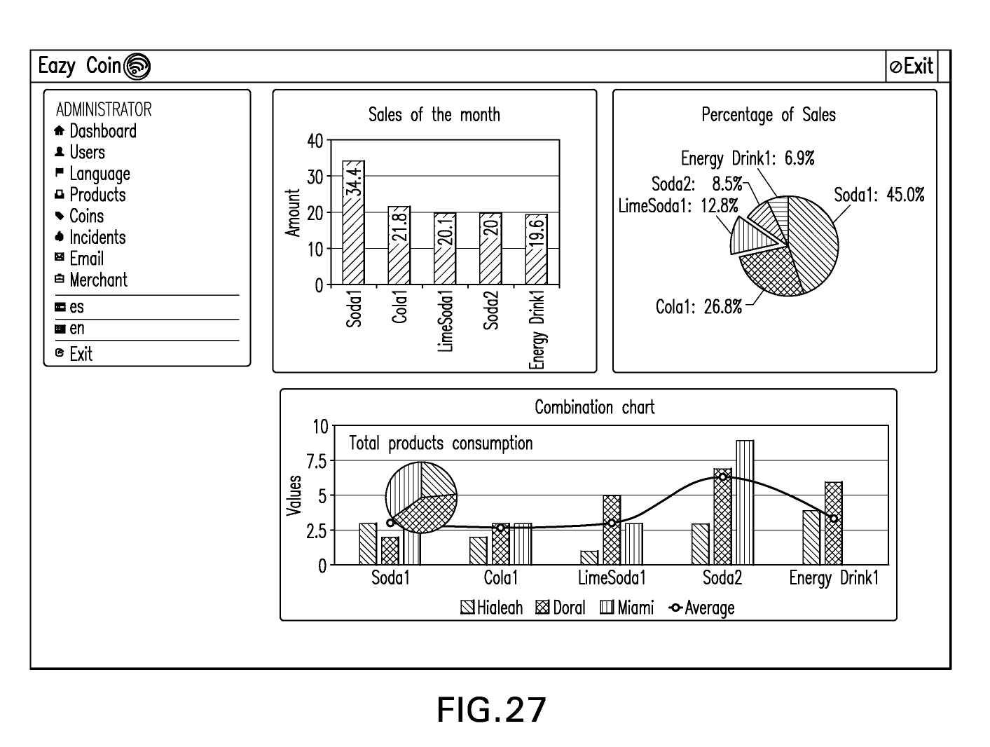

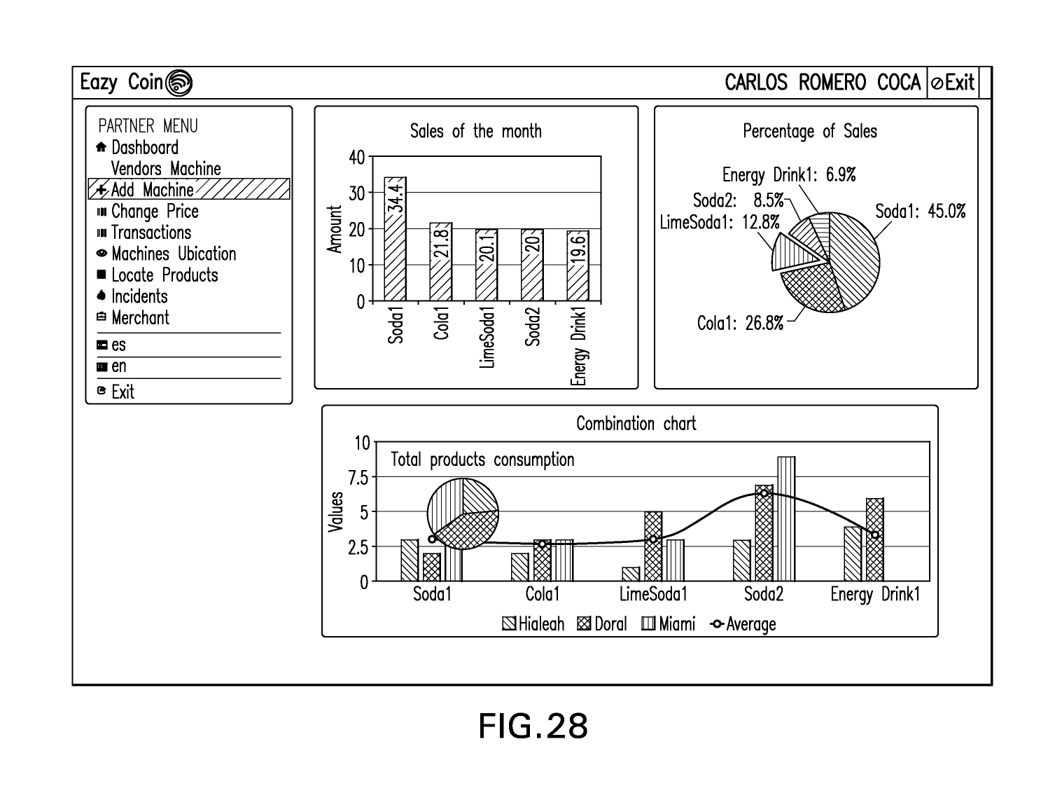

FIGS. 27-28 illustrate sample reports in accordance with one embodiment.

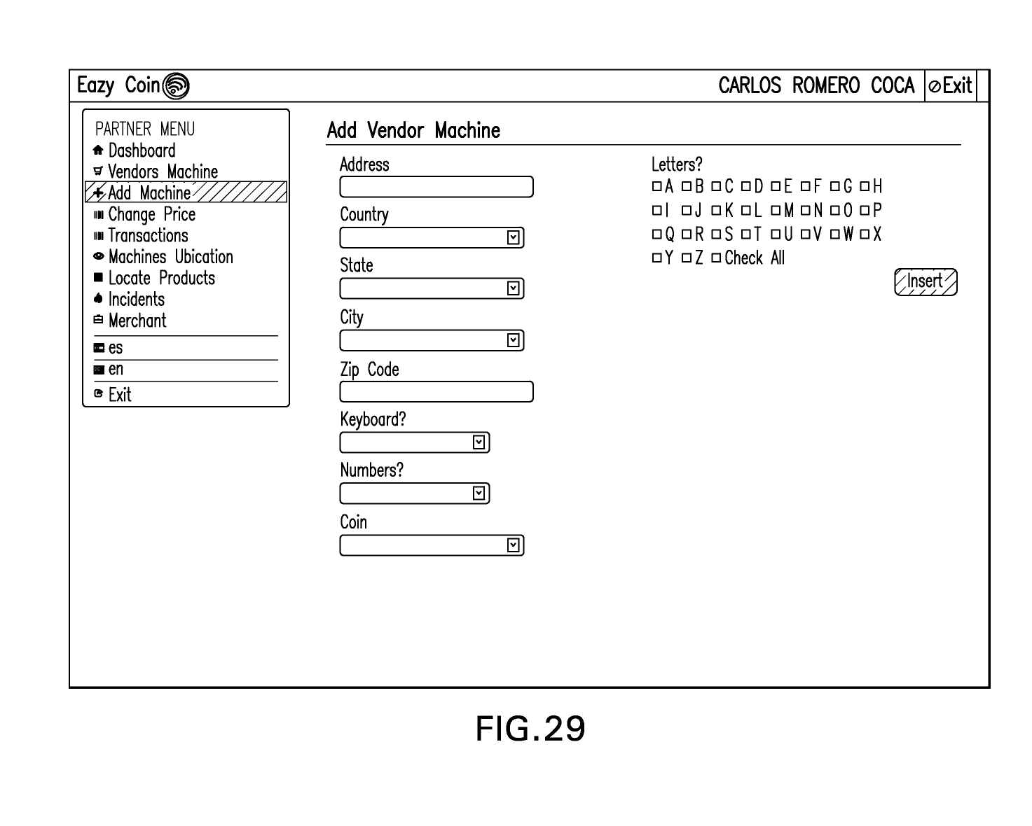

FIG. 29 illustrates a user interface to add a vendor machine in accordance with one embodiment.

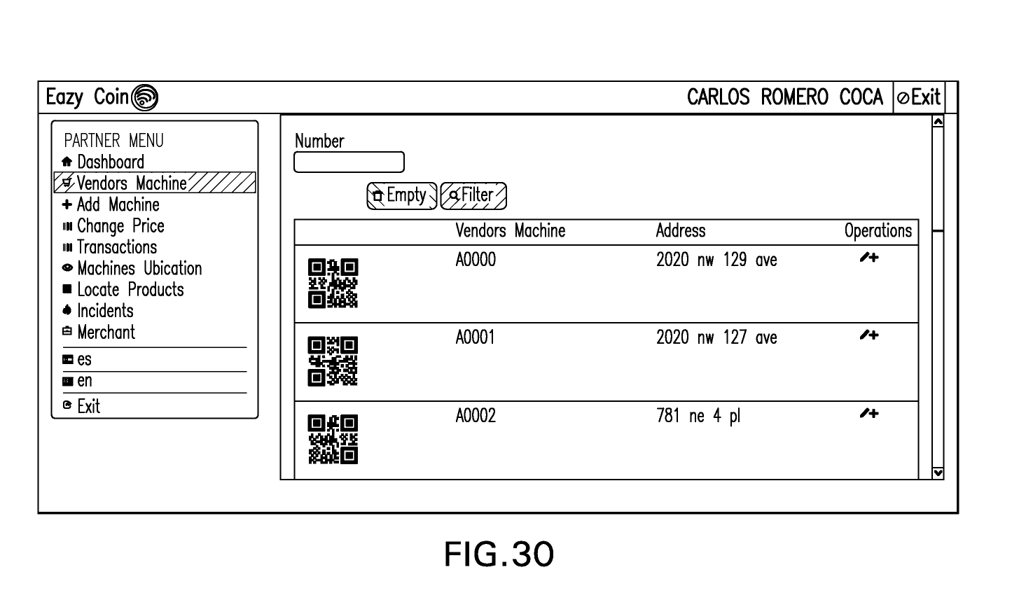

FIG. 30 illustrates a user interface showing vendor machines and their associated QR codes in accordance with one embodiment.

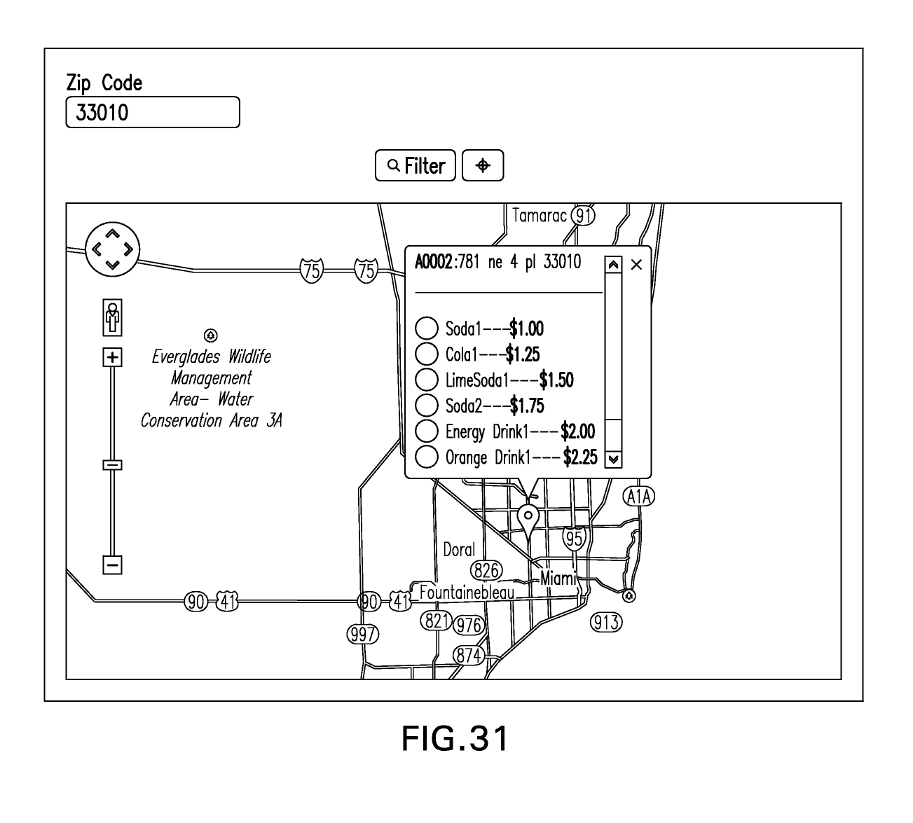

FIG. 31 illustrates a map identifying the location of a vending machine and the products available for that vending machine in accordance with one embodiment.

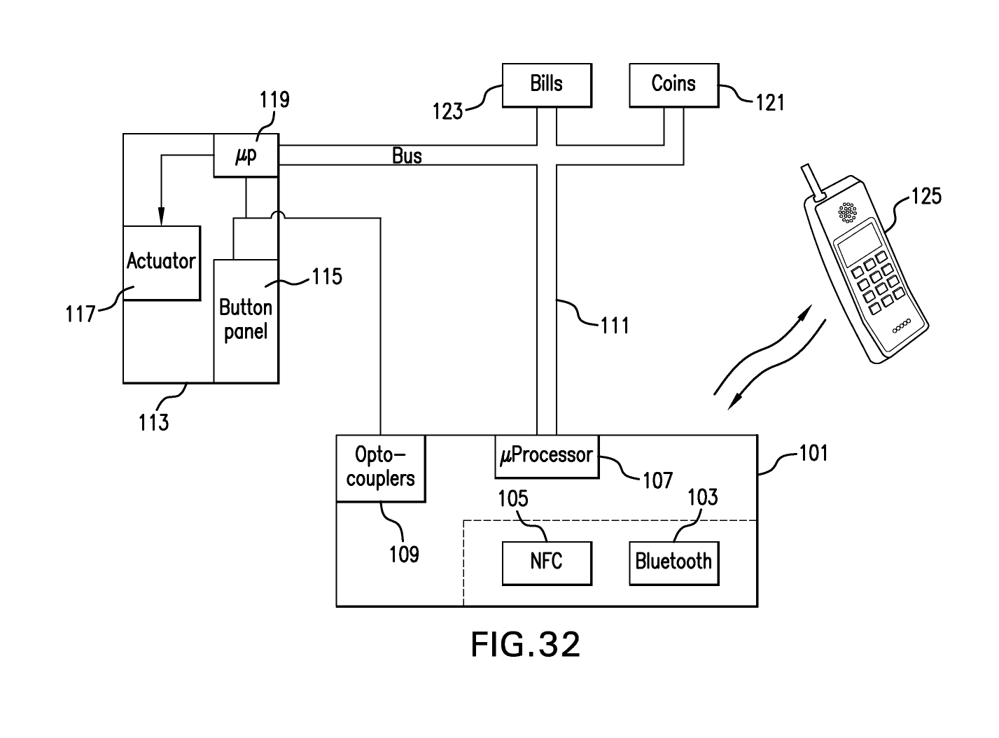

FIG. 32 illustrates a system architecture in accordance with one embodiment. The system may include a vending machine module 113 equipped with a microprocessor 119, an actuator 117 or servo motor for dispatching a product, and a button panel 115 that can be used by a user to select a product. The vending machine module 113 may include additional devices associated with conventional vending machines, such as a credit card slot.

The system may also include a bus 111 that allows communication between the processor 119 and a bill collector 123, a coin collector 121, or the cashless transaction device 101 of the present invention. The cashless transaction device 101 may include a processor 107, opto-couplers 109, and a wireless communications interface used to communicate with the app running in the mobile device 125. The wireless communications interface may include a Bluetooth interface 103, an NFC interface 105, or both. In a preferred embodiment, the bus 111, collectors 123 and 121, vending machine module 113 and cashless transaction device are inside the vending machine housing.

In one embodiment, the user aims the mobile device at the vending machine to scan the corresponding QR code. Once the machine is identified by the app, products available through the vending machine are displayed on the mobile device. The user can then make a product selection through the app and at that point the communication session between the device 101 and the vending machine module 113 initiates through use of the bus 111. Once the communication session is initiated, the processor 119 only listens to the device 101 until the transaction is completed. Upon authorization of the transaction by the merchant or the proprietary server, the processor 119 recognizes the authorization and the vending machine can dispatch the product selected through the app. This may be implemented by use of the opto-couplers, which send a signal to either the processor 119 or the actuator 117. More specifically, the output of the opto-couplers may be multiplexed with the output of the button panel and input into the processor 119 or actuator 117.

Alternatively, if the customer wishes to select a product by pressing buttons on the vending machine, the app may send a request for approval of a transaction to the proprietary server, including a purchase amount corresponding to the most expensive item in the vending machine. Upon authorization of the transaction by the merchant or the proprietary server, the communications session initiates and the processor 119 recognizes the authorization and the vending machine can dispatch the product selected through the button panel. If the selected product has a purchase price that is less than the pre-authorized amount, the user account is credited with the difference.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, while the illustrative embodiments are described with respect to a Bluetooth transceiver, other communication devices may be used as well. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112(f) unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. For example, the teachings of the present invention may be applied to the operation of slot machines. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for handling cashless transactions at a vending machine comprising:
polling a bus to verify receipt of a signal generated by a bill or coin collector, a credit card slot, or a wireless transceiver attached to the vending machine;
at the wireless transceiver, detecting a signal sent by a multi-function mobile device;
selecting the wireless transceiver for communication with a processor in the vending machine;
accepting a product or service selection; and
delivering the product or service.

2. The method of claim 1, wherein said bus is an MDB.

3. The method of claim 1, wherein said signal is a payment verification signal.

4. The method of claim 1, wherein said signal is a product or service selection signal.

5. The method of claim 1, wherein said processor is a VMC.

6. The method of claim 1, wherein said transceiver includes a Bluetooth transceiver.

7. The method of claim 1, wherein said transceiver includes an NFC transceiver

8. The method of claim 1, accepting a product or service selection includes accepting a selection entered through a button panel located at the vending machine.

9. The method of claim 1, accepting a product or service selection includes accepting a selection entered through a software application running in the multi-function mobile device.

10. A cashless transaction device for communication with a vending machine module comprising:
a processor for controlling the operation of the device and for communicating with the vending machine module through a bus;
a wireless transceiver electrically coupled with the processor and for communication with a multi-function mobile device; and
at least an opto-coupler under control of said processor and being configured to send a product or service selection signal to the vending machine.

11. A system for handling cashless transactions comprising:
a vending machine module including a first processor, a button panel, and an actuator; and
a cashless transaction device including a second processor for controlling the operation of the device and for communicating with the vending machine module through a bus, a wireless transceiver electrically coupled with the second processor and for communication with a multi-function mobile device, and at least an opto-coupler under control of said second processor and being configured to send a product or service selection signal to the vending machine.

12. The system of claim 11, wherein said transceiver includes a Bluetooth transceiver.

13. The system of claim 11, wherein said transceiver includes an NFC transceiver.

14. The system of claim 11, further comprising a bill collector.

15. The system of claim 11, further comprising a coin collector.

16. The system of claim 11, further comprising a credit card slot.

17. The system of claim 11, wherein the first processor is a VMC.

18. The system of claim 11, wherein said bus is an MDB.

19. The device of claim 10, wherein said transceiver includes a Bluetooth transceiver.

20. The device of claim 10, wherein said transceiver includes an NFC transceiver.
